(19) United States
(12) Patent Application Publication
(10) Pub. No.: US 2012/0328802 A1
(43) Pub. Date: Dec. 27, 2012

(54) METHOD FOR SURFACETREATING PAPER AS WELL AS PAPER

(75) Inventors: Paul Achatz, Wien (AT); Heidemarie Reiter, Aschbach (AT); Wolfgang Dietl-Schuller, Neuhofen an der Ybbs (AT)

(73) Assignee: Mondi AG, Wien (AT)

(21) Appl. No.: 13/530,511

(22) Filed: Jun. 22, 2012

(30) Foreign Application Priority Data
Jun. 22, 2011 (AT) A914/2011

(51) Int. Cl. B05D 3/12; B41M 5/00; B05D 1/40

(52) U.S. Cl. 428/32.34; 427/331; 427/361

(57) ABSTRACT

In a method for surface-treating paper, in particular paper printable by ink-jet printing, in which an aqueous solution containing at least one water-soluble salt of a bivalent metal and optionally one or several substances selected from a binder, a pigment, a surface sizing agent and/or a cationic polymer is applied to a base paper containing cellulose fibers and optionally fillers, an optical brightener, retention aids or dyes or pigments, an unsized base paper is formed from a pulp comprising cellulose as a main component, between 0 and 50% by weight, in particular 10 and 30% by weight, of CaCO₃ as a filler, and optionally an optical brightener or a retention aid, and the base paper is coated with a liquid surface treatment medium comprising between 1 and 20 kg/t paper of MgSO₄ and the paper is optionally subjected to a post-treatment step.

The present invention relates to a method for surface-treating paper, in particular paper printable by ink-jet printing, in which an aqueous solution containing at least one water-soluble salt of a bivalent metal and optionally one or several substances selected from a binder, a pigment, a surface sizing agent and/or a cationic polymer is applied to a base paper containing cellulose fibers and optionally fillers, an optical brightener, retention aids or dyes or pigments, and a thus produced paper.

Paper, which is a complex product composed of various natural cellulose fibers with pigments, fillers and the like, exhibits strongly different properties as a function of the composition or employed starting materials. In order to adapt the properties of paper to the respective requirements, it is, on the one hand, possible to add a plurality of different substances to said complex composition constituting the base material of paper, or the paper can, on the other hand, be subjected to a surface treatment after having formed a base paper from a pulp and optional pressing and drying, in order to impart the desired, specific properties to the paper. In doing so, the selection of the additives added to the paper in the dehydration process, during drying and for retention enhancement is of decisive importance. For retention enhancement, cationic polymers, nano-particles or several polymers are, for instance, simultaneously added. The effect of these polymers is to retain colloidal particles on the fiber surfaces without causing an agglomeration of the same between the fibers. Other important additives for the modification of the base paper include hydrophobic sizing agents, which are frequently added in the form of emulsions and/or dispersions and serve to attach to the fiber and/or filler surfaces in order to render the same hydrophobic.

In the case of printing paper, it has been known for many years to perform special surface treatments such as, for instance, add salts of bivalent metals to the surface treatment agent as precipitants, dye fixatives and/or coagulants for dyes (ink) in order to improve the properties of the paper in terms of printability.

Thus, EP 0 999 937 B1, for instance, describes a composition that is suitable for surface-treating a substrate for ink-jet printing and, in particular, increasing the color density of a printing ink on paper, which composition contains a bivalent metal ion salt soluble in an aqueous sizing medium, and, in addition, contains starch and a sizing agent as sizing medium. That composition is to improve the ink-jet printability of, and the color density of the ink on, paper.

From US 2009/0297738 ne can gather a coating composition for ink jet paper comprising a calcium carbonate pigment, a metal salt drying agent, a cationic dye fixing agent, a pigment binder and optionally a plastic pigment and optionally a optical brightener, whereby the amount of calcium carbonate pigment is contained in an amount of 70 to 95% of the coating composition.

From WO 96/39304 a ink jet recording sheet has been known, for use with pigment-based inks, whereby at least one of the usable surfaces of the recording sheet includes a combination of a water soluble cationic substance and water soluble binder substance.

From U.S. Pat. No. 6,350,507 B1 one can gather a recording sheet for ink jet printer, wherein a recording sheet is provided on a basic sheet, which recording sheet includes at least a pigment and at least a binder resin, which is deposited on a basic material and additionally a water-soluble divalent metallic salt and glossiness layer.

From WO 2005/0107255 A1 one can gather a recording sheet for use on a digital press comprising a surface layer, which includes a water soluble cationic substance, such as a water soluble bivalent metallic salt and a water soluble binder, which pater is subjected to a digital printing

From EP 1 775 141 B1, a recording sheet of paper can be taken, whose surface was treated with water-soluble calcium chloride to improve its printability.

The present invention now aims to provide a method for producing a paper, and a paper, which is easy to realize and in which, by using fewer components, a paper can be produced, on which a color density at least equivalent to that of prior art products will be achieved in printing while, at the same time, providing reduced bleeding, paper warping and fraying as well as an improved ink/ink gradient of the paper after printing, and faster drying of the printing ink on the paper.

To solve this object, the method according to the invention is characterized in that an unsized base paper is formed from a pulp comprising cellulose as a main component, between 0 and 50% by weight, in particular 10 and 30% by weight, of CaCO₃ as a filler, and optionally an optical brightener or a retention aid, and that the base paper is coated with a liquid surface treatment medium comprising between 1 and 20 kg/t paper of MgSO₄, and that the paper is optionally subjected to a post-treatment step and drying. In that an unsized base paper is initially produced, and said unsized base paper is coated with a liquid surface treatment medium comprising between 1 and 20 kg/t magnesium sulfate and optionally further additives such as a cationic polymer, and the paper is optionally subjected to a post-treatment step, it has become possible to produce, by extremely few operating steps, a paper to which, besides the main components cellulose and calcium carbonate as a filler, which form the base paper, only magnesium sulfate has to be additionally applied as a surface treatment medium. Since temperatures higher than 68° C. occur on the surface of the paper, magnesium sulfate will thereby form a monohydrate on the surface of the paper during the production of paper. At room temperature, the stable form would be magnesium sulfate heptahydrate, which is why during the subsequent printing of paper with water-based inks 0.90 mass units of water can be absorbed per mass unit of used dry magnesium sulfate. During subsequent printing, in particular in an ink-jet process, a thus produced paper will be clearly superior to conventional papers in terms of drying speed. Moreover, the dimensional stability of the paper will be improved, since the water absorbed by the magnesium sulfate will not contribute to the swelling of the fibers, thus preventing bulging of the paper where printed. By way of comparison, the calcium chloride, which is frequently used in surface treatment agents would, for instance, form a dihydrate at the paper production temperatures, yet a hexahydrate at room temperature. A mass unit of the used dry calcium chloride can thus only absorb about 0.65 mass units of water, so that the magnesium sulfate used in the context of the present invention is more effective by 38% in the absorption of water than the conventionally used calcium chloride. If, in this connection, an already dried base paper is anticipated, it will be feasible, by applying a magnesium sulfate solution to the surface of the paper, to rapidly and reliably absorb during the printing of a paper produced according to the invention the liquid contained in the ink by the surface treatment medium magnesium sulfate, so that, in particular, the dot size of a paper treated with magnesium sulfate will be considerably smaller than that of a paper treated with calcium chloride, such a method control in a surprising manner, by using extremely few and specifically selected ingredients, enabling the production of a paper that, in terms of quality, at least corresponds to a conventional paper, which, besides the surface treatment, also contains sizing agents, pigments and other additives.

When printing with water-based pigment inks, the water-soluble magnesium sulfate may partially dissolve in the ink so as to destabilize the pigment dispersion and cause the coagulation of the color pigments. The coagulated color pigment will rather remain on the surface of the paper than penetrate into its interior together with the liquid, which is why the paper treated according to the invention with magnesium sulfate will exhibit a higher color density than untreated paper, when printed with water-based pigment inks.

A further advantage of the method according to the invention resides in the substitution of the less corrosively acting sulfate for the usually contained, highly corrosive chloride, thus extending the service life of the application unit employed for the surface treatment and increasing the lifetimes of the wear parts in the application unit, such as the doctor blades. When recycling rejects, also the input of corrosive chloride into the water cycle of the papermaking machine will be reduced.

In that, as in correspondence with a preferred further development of the method according to the invention, the paper is subjected to calendering or smoothing as said post-treatment step, it has become possible despite the lack of internal sizing agents or further additives to provide a smooth paper free of warps, which can be used in any modern printer. In this respect, it is also irrelevant whether it concerns ink-jet printing or laser printing.

In that, as in correspondence with a preferred further development of the method according to the invention, the paper is smoothed or calendered to a smoothness between 60 and 150 Bekk (s), the fraying of the ink along the fibers will be reduced, being comparable to that of a paper treated by hydrophobization using an internal and/or surface sizing agent. The paper according to the invention is thus well and advantageously suitable for use in both ink-jet printing and laser printing, without involving the formation of warps.

For a particularly simple method control, the method according to the invention is conducted such that the MgSO₄ solution is used as a 0.5 to 20% by weight, in particular 1 to 6% by weight, aqueous solution. By adding magnesium sulfate as a 0.5 to 20% by weight solution, a particularly homogenous distribution of the fixative in the surface treatment medium, and subsequently on the surface of the paper treated therewith, has become possible such that consistent properties over the entire surface of the paper produced by the method according to the invention will be safeguarded.

In that the method according to the invention is preferably conducted in such a manner that the base paper is coated with MgSO₄ as well as a polydiallyldimethylammonium chloride, it has, in particular, become possible to achieve an improved fixation of dye or color inks to the surface of the paper with the simultaneously fast drying of the liquid ink dye composition applied to the surface of a thus produced paper, thus safely excluding the running of colors while, at the same time, ensuring their perfect adhesion to the surface.

A particularly good fixation of the paper surface will be achieved in that the polydiallyldimethylammonium chloride is used in the surface treatment medium at an amount of 1 to 12 kg/t paper. By such a method control, it has become possible to both achieve fast drying of the ink applied to the thus produced paper and prevent running of the same despite the small amounts of surface treatment medium used during the production process.

Particularly favorable properties of a paper produced by the method according to the invention will be achieved in that 1 to 20 kg/t paper, in particular 6 to 10 kg/t paper, of MgSO₄ and 1 to 12 kg/t paper, in particular 4 kg/t paper, of polydiallyldimethylammonium chloride polymer is used as said liquid surface treatment medium.

By such tuning of the input amounts of magnesium sulfate as absorbent and fixative and/or precipitant for pigment inks and the special polydiallyldimethylammonium chloride polymer as fixative for dye inks, it has become possible by extremely few method steps with the simultaneous use of fewer additives to produce a paper that exhibits properties comparable to those of a conventional paper with both internal and surface sizing, yet can be produced in an economically considerably cheaper way.

In that, as in correspondence with a preferred further development of the method according to the present invention, the method is conducted in a manner that a binder such as a native or modified starch, a polyvinyl alcohol or mixtures thereof is additionally used, it has become possible to form a continuous layer on the surface of the paper, that excels by an extremely high uniformity such that not only the dye binding properties but, in particular, also the uniformity of the printability of the paper will be markedly improved by such a method control.

In order to be able to provide a paper having a particularly high whiteness, the method according to the invention is conducted such that a disulfonated, tetrasulfonated, hexasulfonated optical brightener or a distyrylbiphenyl brightener is used. In a surprising manner, the effectiveness of a di-, tetra- or hexasulfonated optical brightener, or a distyrylbiphenyl brightener, is reduced to a substantially smaller extent when using magnesium sulfate than, for instance, by calcium chloride, so that a substantially enhanced whiteness of the paper relative to papers supplemented with, for instance, salts of other bivalent metal ions will be achieved by such a method control.

This effect can even be further improved according to the present invention in that, as in correspondence with a preferred further development of the method according to the invention, the optical brightener is used both in the base paper and in the surface treatment medium.

In the context of the present invention, it has been surprisingly shown that in the subsequent printing of a paper produced according to the invention a uniformly high color density will be achieved in that a pigment selected from the group consisting of ground, precipitated or modified CaCO₃, or mixtures thereof is additionally used in the surface treatment medium. Surface treatment with a pigment alone increases the color density in ink-jet printing relative to an untreated paper, the additional use of MgSO₄ according to the invention results in a further improvement of the color density such that the use of said combination according to the invention will lead to surprisingly advantageous and unexpected results both in papers comprising pigments and in papers free of pigments.

The method according to the invention can thus be used with consistent success both for the production of pigmented paper and for the production of non-pigmented paper.

For a particularly consistent method control and, in particular, for consistent results of the method according to the invention, the method is preferably conducted such that a viscosity regulator such as a polyacrylate is additionally added to the surface treatment medium. Such a method control enables the achievement of a uniform and, in particular, uniformly thick surface treatment coat on the paper.

In order to prevent undesired effects such as the swelling of the binder and the thus involved loss of strength during printing with water-based inks, the method according to the invention is preferably conducted in a manner that a cross-linking agent such as a zirconium salt is added to the binder, in particular starch.

In order to enhance the smoothness of a paper produced by the method according to the present invention, the method according to the invention is preferably conducted such that a lubricant is added to the surface treatment medium. To this end, calcium stearate has proved to be advantageous, resulting both in an enhanced smoothness and in a good printability of the paper.

In a preferred further development of the invention and, in particular, in order to achieve a uniformly and well printable surface layer of the, in particular, pigmented paper, the method according to the invention is conducted such that the total solids content of the surface treatment medium is selected between 15 and 70% by weight, in particular between 30 and 50% by weight. In that the total solids content of the surface treatment medium is selected between 15 and 70% by weight, in particular 30 and 50% by weight, a uniform base paper grain will be achieved, and the thickness of the surface layer to be achieved by applying the surface treatment medium to the base paper will, moreover, be adjustable at will and, in particular, to a minimum requirement.

By such a method control, it is therefore possible according to a preferred further development of the method according to the present invention to obtain an, in particular, pigmented paper which is characterized in that a weight of a dry surface coating comprises 1 to 10 (g/m² side), in particular about 4 (g/m² side). Such a dry surface coating weight corresponds to the weight conventionally applied to printing papers and can be achieved according to the present invention by an extremely simple method control merely requiring magnesium sulfate to be compulsorily contained in the surface treatment medium.

The present invention, in particular, further relates to a paper produced by the method according to the present invention, which is to be preferably usable for ink-jet printing. According to a preferred further development of the invention, such a paper is preferably substantially characterized in that a contact angle of water, in particular distilled water, with the paper ranges between 15° and 70°, in particular between 25° and 50°. It has been surprisingly proved that the paper produced by the method according to the present invention can be used within an extremely wide range of contact angles between water and paper, and that running of the ink or bleaching of the dye will be safely prevented despite such a wide spectrum of used contact angles, which is primarily due to the extremely good drying effect of the used MgSO₄.

In the following, the invention will be explained in more detail by way of exemplary embodiments, in which the paper produced by the method according to the present invention is compared to conventional papers.

### BRIEF DESCRIPTION OF THE DRAWINGS

FIG. 1 shows the average of seven measured ink densities plotted against the salt contents of the coatings;

FIG. 2 shows the time courses of contact angle after application of water droplets plotted against the time; and

FIG. 3 shows the time courses of droplet volumes after application of water droplets plotted against the time.

### EXEMPLARY EMBODIMENT 1

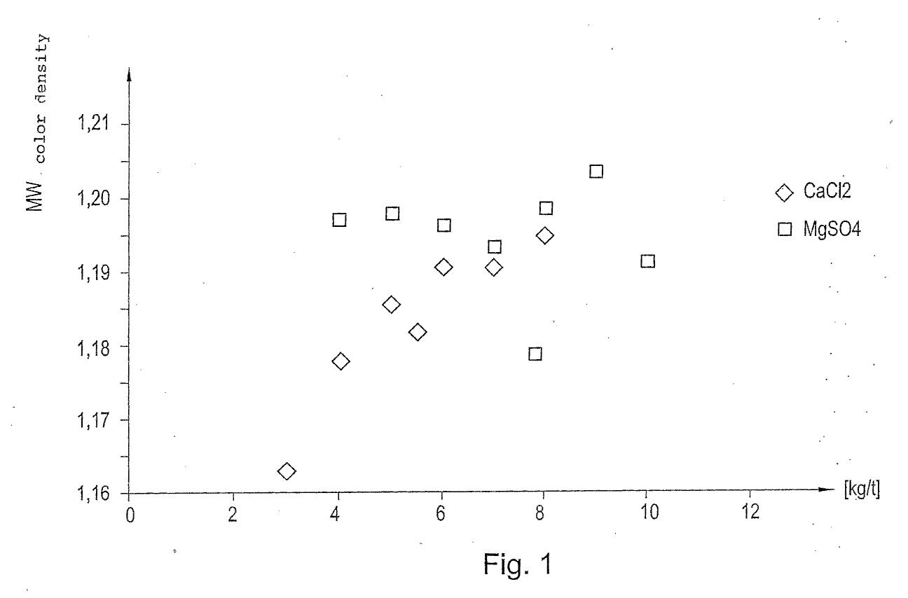

Aqueous solutions of poly-DADMAC (polydiallyldimethyl-ammonium chloride) along with magnesium sulfate in the case of a test paper according to the invention, and calcium chloride in the case of a comparative paper, were respectively applied by the aid of a doctor blade to the test paper and the comparative paper, which were comprised of unsized raw papers with gram weights of 100 g/m². The concentrations were selected such that the content of poly-DADMAC would be 4.7 kg/t and those of CaCl₂ and MgSO₄, respectively, would be 3 to 10 kg/t coated paper at a wet application of 12 (g/m² side) to both sides. However, as a matter of fact, only one side was coated with 12 g/m² wet application of the respective solution and dried. After this, the coated side was printed with a HP Photosmart B9180 printer with the settings “standard/normal paper” using pigment inks. The ink densities of full surfaces of cyan (C), magenta (M), yellow (Y) and black (K) as well as the binary mixed colors red (100 M+100 Y), green (100 C+100 Y) and blue (100 C+100 M) were measured using an X-Rite DensiEye 700 color densitometer. In FIG. 1, the averages of the seven measured ink densities are plotted against the salt contents (calculated for double-side application).

From the evaluation of this printing test, which is shown in FIG. 1, it is clearly apparent that the color density to be obtained with the unsized paper according to the invention is superior or at least equal to that of the conventional unsized comparative paper.

### EXEMPLARY EMBODIMENT 2

An unsized paper with a gram weight of 90 g/m² was formed on a paper machine from a cellulose suspension containing 15% by weight of precipitated calcium carbonate (PCC) as a filler, based on the dry content of the suspension, and a surface treatment medium comprised of an aqueous solution of 2.0% by weight of magnesium sulfate and 1.0% by weight of poly-DADMAC was applied to both sides in a film press such that the content of magnesium sulfate in the finished paper amounted to 7 kg/t. The paper was smoothed to a smoothness of 105 Bekk (s).

### REFERENCE EXAMPLE 1

A sized paper with a gram weight of 90 g/m² was formed on a paper machine from a cellulose suspension containing 18% by weight of precipitated calcium carbonate (PCC) as a filler, based on the dry content of the suspension. Alkenyl succinic anhydride (ASA) was used as a sizing agent, and the sizing amount was adjusted such that the 60 s Cobb value of the finished paper amounted to 30 g/m². In a film press, a surface treatment medium comprised of an aqueous solution of 10% by weight of enzymatically degraded corn starch and 1.8% by weight of CaCl₂ was applied in such a manner that the content of CaCl₂ in the finished paper was 6 kg/t. The roughness was adjusted to a value of 200 ml/min according to Bendtsen, which is the usual value for natural papers.

The papers from Exemplary Embodiment 2 and Reference Example 1 were printed with different printers, and the ink densities were measured as indicated above. In addition, the color density of the black field on the rear side of the paper was measured as a measure for the bleeding of the ink. A HP Photosmart B9180 with standard pigment inks and the printer settings “standard/normal paper”, a Canon MP610 with standard color inks and the printer settings “high/photo glossy paper”, an Epson Stylus S21 filled with Kodak Versamark color inks of the FV2000 series and the printer settings “draft/Epson glossy”, and an Epson Stylus SX218 filled with Océ Jetstream 1000 color inks and the printer settings “photo, Epson Photo” were used as printers. The latter two printers were filled with inks of high-speed production ink-jet printing machines to simulate the performance of the paper on these printing machines.

The results of the color density measurements are summarized in Table 1. From the results, it is clearly apparent that the color density to be achieved with the unsized paper according to the invention is superior or at least equal to that of a conventional sized paper treated with CaCl₂ according to Reference Example 1. In a surprising manner, it was observed that with one of the printers the ink sporadically bled completely through the paper of Reference Example 1, whereas no sporadic bleeding was observed with the unsized paper according to Exemplary Embodiment 2 due to its good absorption properties.

TABLE 1
Evaluation MgSO₄ & Reference

| | | | | | | | | | |
|---|---|---|---|---|---|---|---|---|---|
| | Density | Density | Density | Density | Density | Density | Density | Density | Density bleeding |
| Pattern | cyan | magenta | yellow | red | green | blue | black | Ø | black 100% |

HP PhotoSmart Pro B9180 with standard pigment inks
Settings: standard, normal paper

| | | | | | | | | | |
|---|---|---|---|---|---|---|---|---|---|
| Exemplary | 0.81 | 1.15 | 1.33 | 1.14 | 0.98 | 1.02 | 1.66 | 1.15 | 0.13 |
| Emb. 2 | | | | | | | | | |
| Reference | 0.76 | 1.12 | 1.36 | 1.12 | 0.93 | 0.99 | 1.77 | 1.15 | 0.13 |
| Example 1 | | | | | | | | | |

Canon Pixma MP 610 with standard color inks
Settings: high, photo glossy paper

| | | | | | | | | | |
|---|---|---|---|---|---|---|---|---|---|
| Exemplary | 0.87 | 1.17 | 1.25 | 1.32 | 1.17 | 1.16 | 1.54 | 1.21 | 0.16 |
| Emb. 2 | | | | | | | | | |
| Reference | 0.79 | 1.13 | 1.03 | 1.24 | 1.05 | 1.10 | 1.51 | 1.12 | 0.15 |
| Example 1 | | | | | | | | | |

Epson Stylus S21 adapted with Kodak Versamark color inks (FV2000 series)
Settings: draft, Epson glossy

| | | | | | | | | | |
|---|---|---|---|---|---|---|---|---|---|
| Exemplary | 0.69 | 0.98 | 0.88 | 1.32 | 0.78 | 1.20 | 1.09 | 0.99 | 0.22 |
| Emb. 2 | | | | | | | | | |
| Reference | 0.46 | 0.52 | 0.70 | 0.76 | 0.64 | 1.03 | 0.90 | 0.71 | 0.21* |
| Example 1 | | | | | | | | | |

Epson SX218 adapted with Océ Jetstream 1000 color inks
Settings: Photo, Epson Photo

| | | | | | | | | | |
|---|---|---|---|---|---|---|---|---|---|
| Exemplary | 1.13 | 0.98 | 1.22 | 1.19 | 1.20 | 1.39 | 1.11 | 1.17 | 0.19 |
| Emb. 2 | | | | | | | | | |
| Reference | 0.89 | 0.87 | 1.11 | 1.16 | 0.98 | 1.12 | 1.04 | 1.02 | 0.18 |
| Example 1 | | | | | | | | | |

*sporadical bleeding-through

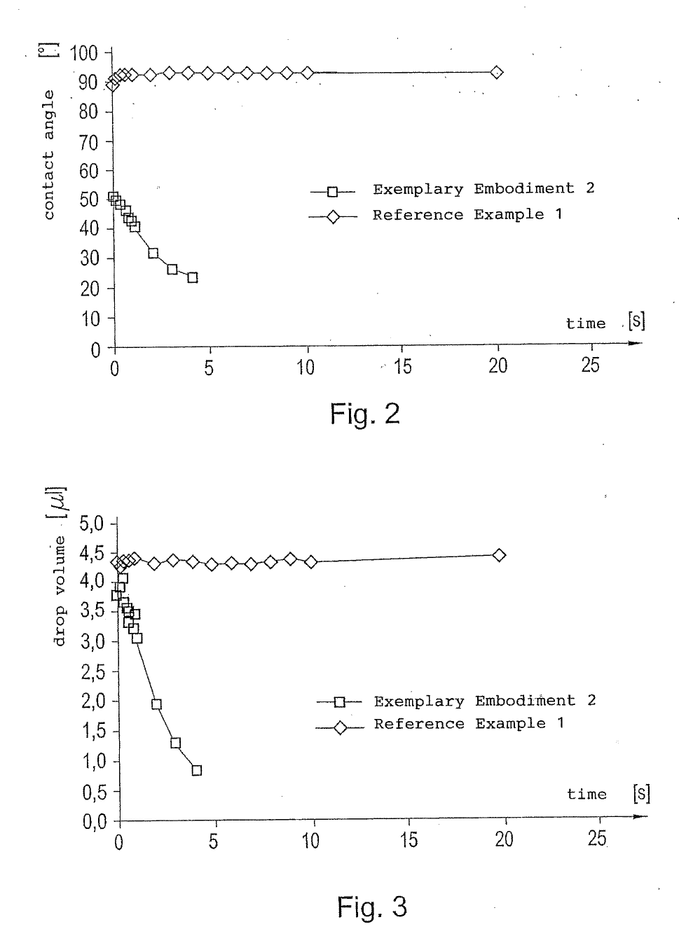

The contact angles on the papers of Exemplary Embodiment 2 and Reference Example 1 were measured with a Pocket Goniometer PGX by Fibro System. The instrument also allows for the calculation of the droplet volume, thus giving good indications on the absorption speeds. FIGS. 2 and 3 depict the time courses of contact angles and droplet volumes after the application of a 4-μl droplet of distilled water to the paper. The contact angles elucidate the differences in hydrophobization between the sized Reference Example and the unsized Exemplary Embodiment. The reduction of the droplet volume shows the considerable advantage in the absorption speed of the droplet with the paper according to Exemplary Embodiment 2.

1. A method for surface-treating paper, in particular paper printable by ink-jet printing, in which an aqueous solution containing at least one water-soluble salt of a bivalent metal and optionally one or several substances selected from a binder, a pigment, a surface sizing agent and/or a cationic polymer is applied to a base paper containing cellulose fibers and optionally fillers, an optical brightener, retention aids or dyes or pigments, characterized in that an unsized base paper is formed from a pulp comprising cellulose as a main component, between 0 and 50% by weight, in particular 10 and 30% by weight, of CaCO₃ as a filler, and optionally an optical brightener or a retention aid, and that the base paper is coated with a liquid surface treatment medium comprising between 1 and 20 kg/t paper of MgSO₄, and that the paper is optionally subjected to a post-treatment step.

2. The method according to claim 1, characterized in that the paper is subjected to calendaring or smoothing as said post-treatment step.

3. The method according to claim 2, characterized in that the paper is smoothed or calendered to a smoothness between 60 and 150 Bekk (s).

4. The method according to claim 1, characterized in that the MgSO₄ solution is used as a 0.5 to 20% by weight, in particular 1 to 5% by weight, aqueous solution.

5. The method according to claim 1, characterized in that the base paper is coated with MgSO₄ polydiallyldimethylammonium chloride.

6. The method according to claim 1, characterized in that the polydiallyldimethylammonium chloride is used in the surface treatment medium at an amount of 1 to 12 kg/t paper.

7. The method according to claim 1, characterized in that 1 to 20 kg/t paper, in particular 6 to 10 kg/t paper, of MgSO₄ and 1 to 12 kg/t paper, in particular 4 kg/t paper, of polydiallyldimethylammonium chloride polymer is used as said liquid surface treatment medium.

8. The method according to claim 1, characterized in that a binder such as a native or modified starch, a polyvinyl alcohol or mixtures thereof is additionally used.

9. The method according to claim 8, characterized in that a cross-linking agent such as a zirconium salt is added to the binder, in particular starch.

10. The method according to claim 1, characterized in that a disulfonated, tetrasulfonated, hexasulfonated optical brightener or a distyrylbiphenyl brightener is used.

11. The method according to claim 10, characterized in that the optical brightener is used both in the base paper and in the surface treatment medium.

12. The method according to claim 1, characterized in that a pigment selected from the group consisting of ground, precipitated or modified CaCO₃ or mixtures thereof is additionally used.

13. The method according to claim 1, characterized in that the total solids content of the surface treatment medium is selected between 15 and 70% by weight, in particular 30 and 50% by weight.

14. The method according to claim 12, characterized in that a weight of a dry surface coating comprising 1 to 10 (g/m² side), in particular about 4 (g/m² side), is selected.

15. The method according to claim 1, characterized in that a viscosity regulator such as a polyacrylate is additionally added to the surface treatment medium.

16. The method according to claim 1, characterized in that a lubricant, in particular calcium stearate, is added to the surface treatment medium.

17. The paper, in particular a paper for ink-jet printing, produced by the method according to claim 1, characterized in that a contact angle of water, in particular distilled water, with the paper ranges between 15° and 70°, in particular between 25° and 50°.
